(19) United States
(12) Patent Application Publication
(10) Pub. No.: US 2008/0206691 A1
(43) Pub. Date: Aug. 28, 2008

(54) Phosphor screen in rare gas discharge device

(75) Inventors: Lyuji Ozawa, Poughkeepsie, NY (US); Chun-Hui Tsai, Tainan (TW)

Correspondence Address: BIRCH STEWART KOLASCH & BIRCH, PO BOX 747, FALLS CHURCH, VA, 22040-0747, US

(73) Assignees: CHI-MEI CORPORATION; NULIGHT TECHNOLOGY CORPORATION

(21) Appl. No.: 11/709,264

(22) Filed: Feb. 22, 2007

(51) Int. Cl. G03C 7/32

(52) U.S. Cl. 430/542; 430/541

(57) ABSTRACT

The present invention provides a phosphor screen in a Xe gas discharge device such as a plasma display device or a mercury-free flat fluorescent lamp, which phosphor having a clean surface that emit a brighter photoluminescence under the vacuum ultraviolet lights from Xe gas discharge, and which gives a wide rendering of color images on screens of PDP and LCD, and furthermore the invention provides the remarkable reduction of the production cost of PDP and Hg-free FFL.

### BACKGROUND OF THE INVENTION

1. Field of the Invention

The present invention relates to a rare gas, especially a xenon Xe gas discharge device, and more particularly to a phosphor screen used in a plasma display device (hereinafter as PDP), and a mercury-free (hereinafter as Hg-free) flat fluorescent lamp (hereinafter as FFL) as a light source, more precisely, the phosphor screens provide a wide rendering of color images on the screen of PDP and LCD, as well as a high luminance. Furthermore, the present invention relates to a reduction of production cost of PDP, by means of a simplification of structure of rare gas discharge chamber by an application of the appropriate phosphor screens.

2. Description of the Related Art

PDP and Hg-free FFL utilize photoluminescence (hereinafter as PL) from phosphor screens under irradiation of the 142 nm and 172 nm invisible vacuum ultraviolet (hereinafter as VUV) lights from the Xe gas discharge in vacuum vessels. PDP and Hg-free FFL have the same VUV lights from Xe gas discharge. A difference is the arrangement of the phosphor screens on a flat glass plate. PDP display's color images on screens are made by a side by side arrangement of the narrow lines of the color phosphor screens on a base glass plate (rear glass substrate). The width of the line phosphor screens corresponds to the color image segment (pixel) on PDP screen. The searching studies of PL phosphors have a long history for more than 50 years. For instance, [Phosphor Handbook, CRC Press, Boca Roton, Fla., 1998, and Ohm Publishing, Tokyo, Japan, 1987 in Japanese] cites many color phosphor powders. As limited to the Eu activated phosphors, there are (Y,Gd)BO₃:Eu³⁺, Y₂O₂S:Eu³⁺, Y₂O₃:Eu³⁺, BaMgAl₁₀O₁₇:Eu²⁺, CaAl₂O₄:Eu²⁺, SrAl₁₄O₂₅:Eu²⁺, Sr₂P₂O₇:Eu²⁺, (Sr,Ca)B₄O₇:Eu²⁺, Ca₂B₅O₉Cl:Eu²⁺, Ba_{0.75}Al_{17.25}O₁₇:Eu²⁺, InBO3:Eu³⁺, (BaMg)Si₂O₅:Eu²⁺, YAl₃(BO₃)₄:Eu²⁺, LaAlO₃:Eu³⁺, and so on. You may find a most historical phosphor of ZnS family phosphors in the handbooks. Furthermore, many other phosphors find in the other publications. Under irradiation of the VUV lights, however, many of the cited phosphors do not emit PL and some of them emit weak PL intensities. They are out of the consideration of the practical use in the phosphor screens in PDP and Hg-free FFL. A limited number of the phosphors have been considered for the practical use in PDP and Hg-free FFL. Table 1 shows the practically considered phosphors selected among them. The phosphors in Table 1 are the commercially available from the phosphor market for PDP and FFL. A triad on a color phosphor screen of PDP and lamp for LCD comprises red, green, and blue phosphors, which are selected from the color phosphors listed in Table 1. Phosphor screens in Hg-free FFL as backlight of color LCD should emit a white PL, which are traditionally made by blend mixture of the color phosphor powders listed in Table 1.

TABLE 1
Typical red, green and blue phosphors considered for PDP and FLL

| Red | Green | Blue |
|---|---|---|
| Y₂O₃:Eu³⁺ | LaPO₄:Ce³⁺:Tb³⁺ | BaMgAl₁₀O₁₇:Eu²⁺ |
| (Y,Gd)₂O₃:Eu³⁺ | MgAl₁₁O₁₉:Ce³⁺:Tb³⁺ | BaMg₂Al₁₆O₂₇:Eu²⁺ |
| (Y,Gd)BO₃:Eu³⁺ | GdMgB₅O₁₀:Ce³⁺:Tb³⁺ | (Sr,Ba,Ca)₅(PO₄)₃Cl:Eu²⁺ |
| Y(V,P)O₄;Eu³⁺ | Y₂SiO₅:Tb | |
| | BaMgAl₁₀O₁₇:Eu²⁺:Mn²⁺ | |

The phosphors in Table 1 are also widely used in fluorescent lamps (hereinafter as FL), which the phosphor screens emit PL under irradiation of the 254 nm ultraviolet light (hereinafter as UV) from the low pressure Hg discharge, although the different excitation mechanisms involve in the generation of PL by the VUV lights and the 254 nm UV light. The phosphors also emit luminescence under irradiation of electrons, but the phosphors in Table 1 can not be used in the phosphor screens of practical CRTs with the reason of dim cathodoluminescence (hereinafter as CL). It can say historically that the color CL phosphors for the practical CRTs have been selected from the phosphors, which have been developed for 50 years, as the best phosphors that give the highest luminance with a wide color rendering. A question arises as to why the designers of PDP and Hg-free FFL have selected the phosphors listed in Table 1 without considering the practical CL phosphors.

The inventors of the present invention have found that the designers have selected the phosphors based upon their empirical results, because of the vagueness of the luminescence mechanisms of the phosphors. The vagueness in the selection of the phosphors comes from the different excitation mechanisms involved. The inventors of the present invention consider there are two different excitation mechanisms involved in the PL phosphors, (i) direct excitations of the luminescent centers (activator) by the UV lights and (ii) indirect excitation of the activators via host-lattice excitation that generates pairs of electrons and holes (hereinafter as EHs) in the crystal and emit luminescence by the recombination of EHs at activators. The activators in the red FL phosphors in Table 1 are excited by the 254 nm UV light that corresponds to the charge transfer absorption (electron transfer from activators to surrounding anions in the crystal). The excitation by the charge transfer absorption belongs to the direct excitation. The absorption coefficient of the charge transfer band corresponds to that of the host-lattice excitation. The Tb³⁺ and Mn²⁺ of the green phosphors in Table 1 emit green PL by receiving the energy from excited Ce³⁺ and Eu²⁺, respectively, which are directly excited by the VUV and UV lights. The green phosphors in Table 1 belong to the direct excitation. The blue phosphors in Table 1 use f-d transition of Eu²⁺, which belongs to direct excitation by the incident lights. Under irradiation of electrons, the directly excited activators are dim CL, because the activator number at lattice site is given by the mole fraction of the activator concentrations; about 0.01. The number of the excited host lattices by electrons is 100 times of the direct excitation. The red phosphors in Table 1 belong to the host lattice excitation. The CL phosphors generate CL by the recombination of EHs at activators which belong to the host-lattice excitation.

The host crystals of the red phosphors listed in Table 1 have the band gap around 5 eV (220 nm), longer than the 172 nm VUV lights. Therefore, the same excitation mechanism involves in the excitation of Eu³⁺ in the red phosphor screens in PDP, Hg-free FFL, and CRT. In general, the host lattice excitation gives the brighter luminescence. Then, a question arises as to why the designers of PDP and Hg-free FFL do not use the best CL phosphor screens that is Y₂O₂S:Eu³⁺ red phosphor. The designers of PDP and Hg-free FFL have had the results that the commercial Y₂O₂S:Eu³⁺ CL red phosphors do not emit PL under the VUV lights.

### SUMMARY OF THE INVENTION

The inventors of the present invention have found the concealed factors of the practical CL phosphors for the PL application. By removal of the concealed factors of the CL phosphors, the practical CL phosphors become the brighter PL phosphors which provide a wide color rendering of the images on screens of PDP and lamps for LCD, as well as a high luminance. Beside the PL generation, the invented phosphor screens also emit CL by irradiation of the electrons and positive ions from a rare gas discharge, especially a Xe gas discharge. The emitted CL adds to the PL output from the screen. The image quality of PDP and LCD is the same with the image quality on CRT screens. Furthermore, the bulk of the CL phosphor particles exhibit a peculiar property under the host-lattice excitation. That is the anisotropic mobility of the electrons in front of the phosphor screens, giving rise to a high surface conductance of the electrons. The production cost of PDP is significantly lowered by substitution of both MgO thin film and dielectric layer by the powdered screens of the invented phosphors.

The present invention provides a phosphor screen for PDP or FFL which have wide color rendering of the images on screens and high luminance.

According to one aspect of the present invention, the phosphor screen for PDP or FFL comprises phosphors of Y₂O₂S:Eu³⁺, Y₂O₂S:Pr³⁺, and ZnS:Ag:Cl having a clean surface for emission of photoluminescence under irradiation of vacuum ultraviolet lights.

According to another aspect of the present invention, the phosphor screen for PDP or FFL comprises phosphors of Y₂O₂S:Eu³⁺, Y₂O₂S:Pr³⁺, and at least one selected from BaMgAl₁₀O₁₇:Eu²⁺, BaMg₂Al₁₆O₂₇:Eu²⁺, and (Sr,Ba,Ca)₅(PO₄)₃Cl:Eu²⁺, of which phosphors Y₂O₂S:Eu³⁺ and Y₂O₂S:Pr³⁺ have a clean surface for emission of photoluminescence under irradiation of vacuum ultraviolet lights.

According to still another aspect of the present invention, the phosphor screen for FFL comprises a phosphor selected from those of Y₂O₂S:Eu³⁺:Tb³⁺ and Y₂O₂S:Eu³⁺:Tb³⁺:Pr³⁺ having a clean surface for emission of photoluminescence under irradiation of vacuum ultraviolet lights.

### BRIEF DESCRIPTION OF THE DRAWINGS

FIG. 1 is a cross-sectional view of a conventional white emitting phosphor screens in Hg-free FFL;

FIG. 2 is a cross-sectional view of a conventional color phosphor screens in color PDP; and

FIG. 3 is a cross-sectional view of the color phosphor screen in a color PDP in accordance with the preferred embodiment of the present invention.

### DETAILED DESCRIPTION OF THE PRESENT INVENTION

Luminescence of phosphors is generated at activators in phosphor particles, and luminescence color of phosphors is solely determined by the kind of activators. Therefore, luminescence color is the same with PL and CL. Difference is the excitation means that are electrons and photons. Practical CL phosphors are irradiated under electrons of the energy of 25 keV, and PL phosphors are irradiated by photons of the energy of about 4 to 7 eV. The penetration depth of the ionized elements in to the phosphor particles is not clear, but the phosphors emit CL by the ion bombardment, suggesting that the similar excitation mechanisms with the electrons are involved by the ion bombardment. The incident electrons penetrate in to crystals by collision with lattice ions, and the penetration depth of the electrons in to phosphor particles is around 0.5 μm. The crystals absorb photons by lattice resonance with frequencies of photon waves, and the resonated lattice ions are limited with the lattice ions in the surface volume. The penetrated depth of the lattice resonance is less than 0.1 μm. The PL phosphors are sensitive with the surface contamination which absorbs the incident VUV lights.

Phosphor particles are compounds which are composed of anions and cations that have a difference in ionic radii (cations<anions). In general, anions are arranged at the most top layer of compounds. As the anions have a large radius as compared with that of the cations, the anions are unstable at crystal boundary of grown particles. Unstable anions escape from the surface volume of the grown particles, leaving anion vacancies. The surface volume having the anion vacancies does not form the luminescent center. They are insulators but they have the absorption band in the same wavelength range with the absorption band of the compounds. Cations of many phosphor compounds are Mg, Ca, Sr, Ba, Zn and Y which the ionic radii are around 1.0 Å. Anions are divalent O and S which have the ionic radii of 1.4 Å and 1.8 Å, respectively. The oxide compounds have less surface vacancies with the small difference (about 40%) between ionic radii of cation and anion, and the sulfide compounds have many surface vacancies with the large ionic radii difference (about 80%). This is a reason that all host crystals of the PL phosphors listed in Table 1 are oxide compounds. The practical CL phosphors are sulfides. The above description does not explain why the red phosphor in Table 1 does not include CL phosphors. The energy loss of the incident electrons by the penetration through the layer of the surface vacancies is negligibly small (about 110 eV). Consequently, the same energy of the electrons gives to oxide and sulfide phosphors. The brilliant luminescence of the CL phosphors indicates that the practical CL phosphors are essentially brighter than the PL phosphors listed in Table 1 under irradiation of the VUV lights.

The inventors of the present invention have found a crucial reason that is the particle sizes. The average particle sizes of the red phosphors in Table 1 are around 2 μm that is a half of the sizes of CL phosphors (around 4 μm). The particle sizes of around 2 μm correspond to the seed particle size in the phosphor production, and the growth from the seed particles is hard for the red phosphors in Table 1. It is commonly known that the large CRT phosphor particles are grown by a flux action. The surfaces of the grown phosphor particles of the commercial CL phosphors are heavily contaminated with the thin film of the residuals of the by-products of the raw materials and interface layer of the compounds of host crystal and melted by-products.

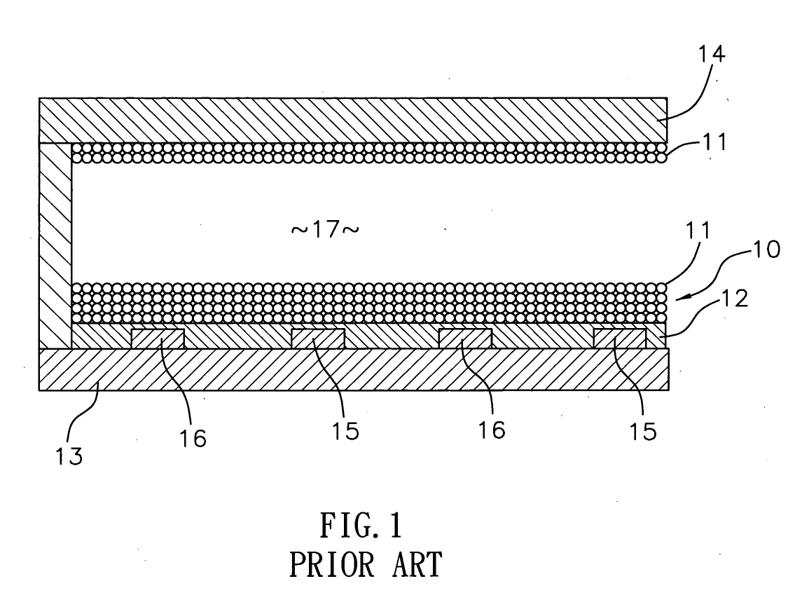

For instance, the typical Y₂O₂S:Eu³⁺ red CRT phosphors are produced by a large amount of the melted Na₂S₄ and Na₂S in phosphor production. At the high temperatures above 1100° C., some amount of the melted Na₂S₄ diffuses in the surface volume of the grown Y₂O₂S particles, forming the interface compound of Y₂O₂S and Na₂S₄. Consequently, the surface of grown Y₂O₂S particles is covered by the interface layer, which can not be removed from the surface of the grown Y₂O₂S particles by ordinary phosphor production process. The interface layer is not emissive and it is insulator. Beside the insulator, the interface layer has the absorption band which coincides with the absorption band of the host lattice. Therefore, the commercial Y₂O₂S phosphor does not emit PL under irradiation of the VUV lights. The book of [cathodoluminescence and photoluminescence, theories and practical application, Kodansha-VHC, Tokyo Japan, 1990] has described a cleaning process of the interface layer that is the removal of the interface layer of Y₂O₂S:Eu³⁺ phosphor, which emits CL under the electrons of 300 eV. The commercial Y₂O₂S:Eu³⁺ phosphor only emits CL with the electrons having energy of above 1500 eV. The phosphor has been developed for a use of a special CRT in industrial use. Similarly, the white emitting CL phosphor can be made with Y₂O₂S:Eu³⁺:Tb³⁺ phosphor. After the complete removal of the interface layer, the Y₂O₂S:Eu³⁺:Tb³⁺ white emitting phosphors are also used as the phosphor screen in other special CRT, like as head mounted miniature CRT and viewfinder of camcorders. The inventors of the present invention have found that the Y₂O₂S:Eu³⁺:Tb³⁺, Y₂O₂S:Eu³⁺:Tb³⁺:Pr³⁺ white emitting phosphors emit a brilliant PL under VUV lights. Therefore, the Y₂O₂S:Eu³⁺:Tb³⁺ white emitting phosphor having a clean surface is applicable to the phosphor screens in Hg-free FFL as the white light source. FIG. 1 illustrates the cross-sectional view of a Hg-free FFL vessel 10 comprises a phosphor screens 11 on an insulator layer 12 on a base plate glass 13, and a front glass plate 14. The insulator layer 12 embeds electrodes 15 and 16. The FFL vessel 10 fills rare gas 17, for example, Ar, Ne, Kr, Xe or mixture of Xe gas and other rare gases, wherein the preferable gas is Xe.

The inventors of the present invention have found the additional effort that because of the clean surface, the phosphor screens emit CL by the irradiation of the electrons and positive ions (Xe⁺) which diffuse out from the plasma discharge. The emitted CL is the same PL color, and the quantum efficiencies by the electrons and positive ions are very high (a few hundred to thousand) as compared with the quantum efficiency by the photons (maximum=1). The emitted CL adds to the PL output from the phosphor screens in PDP and Hg-free FFL. PL luminance of the invented phosphor screens goes up to 50% from that of the phosphor screens in the conventional PDP and Hg-free FFL. In the present invention, phosphors having a clean surface means phosphors that emit CL under electrons of 300 eV.

Hg-free FFL is also used as a backlight of LCD. Color rendering of images on screens on LCD and PDP is an important concern in the practice. PL colors of phosphors are simply determined by kinds of activators. For instance, the red phosphors in Table 1 use the electrons transitions of the Eu³⁺, and the green phosphors use the combinations of Ce³⁺ and Tb³⁺, and/or Eu²⁺ and Mn²⁺, and the blue phosphors use Eu²⁺. Although the kinds of the activators determine the PL color, a small difference appears with the different compositions of phosphor crystals. The small difference of PL color comes from the small difference of split levels of the activators by electrostatic crystal field (the Stark effect). The Stark effect gives the small difference in the energy of the emitted photons. This is especially true with the red phosphors that the human eyes sensitively perceive a small difference in the red region; orange to red, like as scenery of sunset for warning to dark. The color difference in the green (Tb³⁺) and blue (Eu²⁺) phosphors is a negligibly small with the host crystals. The activators should be changed with respect to the change in the PL color with the green and blue phosphors.

For obtaining better color rendering images on the eyes, the PL from the phosphors should have the PL that gives color locus of x-y color coordinates. The better color rendering from the phosphor screens are only obtained with narrow PL lines, instead of a PL band. The red phosphors in Table 1 have the PL lines due to electronic transitions from the excited state ⁵D₀ to ground levels of ⁷Fⱼ Eu³⁺, wherein J=0, 1, to 7. A pure color rendering of the red phosphors is obtained with the longer wavelengths as possible. The peak wavelengths of the red phosphors are well studied in last 30 years in CRT application. Table 2 summarized the results shows below. In Table 2, there is a red Y₂O₂S:Eu³⁺ phosphor, which has the peak line at 626 nm, gives a highest color rendering with a high luminance. This is a reason that the CRT designers have selected Y₂O₂S:Eu³⁺ red phosphor. Unfortunately, the commercial CL Y₂O₂S:Eu³⁺ has not applied to the phosphor screen of PDP and Hg-free FFL with the reasons of not having a clean surface.

TABLE 2
Red phosphors having different peak wavelengths (nm)

| Red phosphors | Peak wavelengths (nm) |
|---|---|
| Y₂O₃:Eu³⁺ | 611 |
| (Y,Gd)₂O₃:Eu³⁺ | 611 |
| (Y,Gd)BO₃:Eu³⁺ | 596 |
| Y(V,P)₄:Eu³⁺ | 619 |
| Y₂O₂S:Eu³⁺ | 626 |

Most of the green phosphors in Table 1 use the double activators; Ce³⁺ and Tb³⁺, and Eu²⁺ and Mn²⁺. The green PL of the phosphors having Ce³⁺ and Tb³⁺ is determined by the Tb³⁺ PL that is a group of the PL lines at around 541 nm. The green PL of the phosphors having Eu²⁺ and Mn²⁺ is determined by the Mn²⁺ that gives the PL band, not line, peaked at 513 nm. It is well known in early CRT study that the decay time of Mn²⁺ PL is longer than 30 msec that gives the smeared green images on the phosphor screens of CRT. The best color rendering of the green light is PL lines at around 515 nm with a short decay time; hopefully less than 1 msec. It is known that Y₂O₂S:Pr³⁺ emit the lines at around 514 nm with decay of a few μsec, giving rise to a clear green images as compared with other green phosphors, as shown in Table 3. After removal of the interface layer from Y₂O₂S:Pr³⁺, that is Y₂O₂S:Pr³⁺ having a clean surface, the Y₂O₂S:Pr³⁺ phosphor emits PL under the VUV lights and CL under irradiation of the electrons of positive ions from the plasma discharge. Unfortunately, there is no blue Y₂O₂S phosphor. The inventors of the present invention have found the low voltage ZnS:Ag:Cl and/or ZnS:Ag:Al blue CL phosphor can be used as the blue phosphor screens in PDP and Hg-free FFL.

TABLE 3
Green phosphors having different peak wavelengths (nm)

| Green phosphors | Peak wavelengths (nm) |
|---|---|
| LaPO₄:Ce³⁺:Tb³⁺ | 541 |
| MgAl₁₁O₁₉:Ce³⁺:Tb³⁺ | 541 |
| GdMgB₅O₁₀:Ce³⁺:Tb³⁺ | 541 |
| Y₂SiO₅:Tb | 541 |
| BaMgAl₁₀O₁₇:Eu²⁺:Mn²⁺ | 513 |
| Y₂O₂S:Pr³⁺ | 514 |

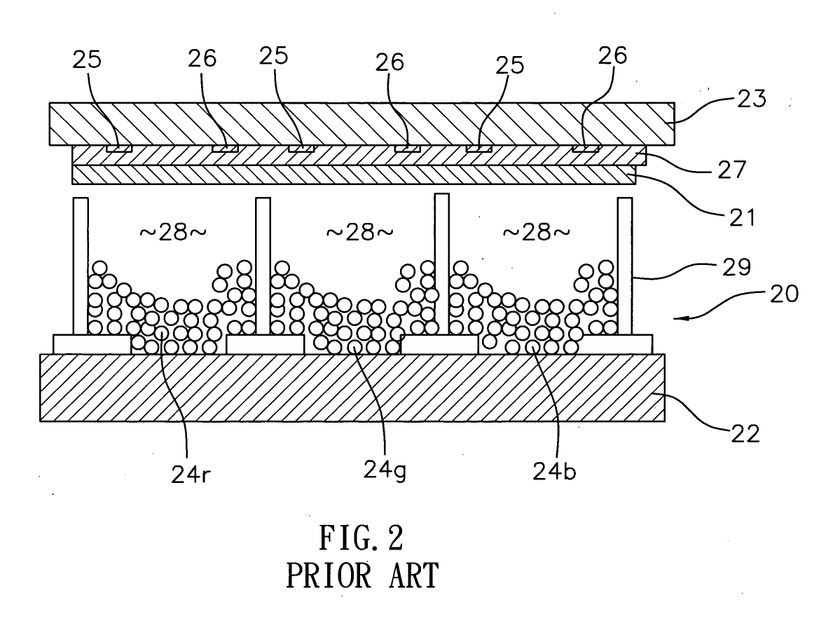

Therefore, a preferable combination of color phosphors for PDP and Hg-free FFL as backlight is Y₂O₂S:Eu³⁺ (red), Y₂O₂S:Pr³⁺ (green), and at least one of the blue phosphors of BaMgAl₁₀O₁₇:Eu²⁺, BaMg₂Al₁₆O₂₇:Eu²⁺, and (Sr,Ba,Ca)₅(PO₄)₃Cl:Eu²⁺. A most preferable combination of color phosphors for PDP and Hg-free FFL is Y₂O₂S:Eu³⁺ (red), Y₂O₂S:Pr³⁺ (green), and ZnS:Ag:Cl and/or ZnS:Ag:Al (blue). The blend mixture of above phosphors is for the phosphor screen of the Hg-free FFL as backlight. The inventors of the present invention found that preferable phosphors for the Hg-free FFL as backlight for LCD are Y₂O₂S:Eu³⁺:Tb³⁺ and Y₂O₂S:Eu³⁺:Tb³⁺:Pr³⁺, which emit the strong PL lines which distribute on the entire wavelengths in the visible spectrum. Since the phosphor screen consists of a single phosphor component, the problem of the color shift with operation time is solved by the application of Y₂O₂S:Eu³⁺:Tb³⁺ or Y₂O₂S:Eu³⁺:Tb³⁺:Pr³⁺ phosphor. FIG. 2 illustrates partial of cross-sectional of the phosphor screens in the conventional PDP structure. Electrodes 25 and 26 is disposed on a front plate 23 and covered by an insulator layer 27. The insulator layer 27 is cover by a protection layer 21. The front plate 23 and an opposing rear plate 22 forms a space which is filled with discharge gases 28, such as rare gas mixture. A rib structure 20 between the front plate 23 and the rear plate 22 subdivides the space into discharge cells. Red phosphor screen 24r, green phosphor screen 24g, and blue phosphor screen 24b are screened between ribs 20, respectively.

CRT phosphors have a long lifetime that holds the initial CL intensities (100%) more than 50,000 hours. The decrease in the CL intensities of CRT screen is not by CL phosphors, but is caused by the lifetime of the oxide cathodes. The lattice ions in the CL phosphors are well crystallized particles, which do not displace the lattice sites by the irradiation of 30 keV electrons and ion bombardment in CRT. The glass is amorphous (non-crystalline) solid, and bonding force of ions in amorphous solids is very weak as compared with the lattice-bonding force in crystals. Therefore, Na ions in glass may easily move out from the original place with the ion bombardment. It can be said that the degradation of the PL intensities in the Xe gas chamber is not caused by the phosphors. The similar story of the degradation of luminescence intensities has been experienced in the CRT development in the past. The decrease CL intensities were always misleadingly attributed to the phosphors. The fact was different from the imagination. The coloration of the phosphor screens in CRT is due to adsorption of the residual gases on the surface of phosphor particles in the sealed CRT. It is not formation of a color center in the CL phosphor particles. The CL phosphor screen has a pumping action of the residual organic gases by adsorption. The coloration of the CL phosphor screens occurs by partial decomposition of the adsorbed organic materials. The coloration of the phosphor screens have taken away from CRT screens by the application of the advanced vacuum technology. The different degradation of the phosphors in Table 1 is caused by the adsorption of the residual gases by the anion vacancies, of which the amount differs with the phosphor production.

The inventors of the present invention have found followings by the application of the invented phosphors to the screens in PDP and Hg-free FFL. As the phosphor screens in PDP and Hg-free FFL are made by the invented phosphor screens, the phosphor screens have a high surface conductance of electrons. This is a great advantage of the production cost of PDP and Hg-free FFL. Especially, this is a true for PDP production. Referring to FIG. 2 again, PDP has been used the MgO thin film layer 21 (protection layer) on dielectric glass layer 27 (insulator layer) which embeds the electrodes 25 and 26. Xe gas discharge is made in the Xe gas chamber by acceleration of the surface-conductive electrons in front of the MgO thin film above the electrodes. The designers of PDP have assumed that MgO thin film has a high emission of the secondary electrons. In reality, MgO thin film only emits the secondary electrons as the incident electrons and positive ions have penetrated in to the MgO thin film. Otherwise, there is no emission of secondary electrons from MgO thin film. Another claim is that MgO thin film is a protection layer from the ion bombardment. As described above, the dielectric layer above electrodes is glass layer which is formed amorphous solid. The phosphor particles are well crystallized particles at the high temperatures, which have the high crystal energy, and the phosphor particles do not damage by the ion bombardment in PDP and Hg-free FFL.

By the study of the inventors of the present invention, some amount of the electrons and positive ions, as a consequence of ionization of Xe gas, are accelerated and then penetrate in to the invented phosphor particles in the Xe gas chamber, because the phosphor particles have the clean surface. Subsequently, the phosphor particles emit CL. Beside CL generation, the phosphor particles emit secondary electrons in vacuum, leaving holes in surface volume of the phosphor particles. In general, the phosphor particles are insulator, like as the blue and green phosphors in Table 1, which PL is not generated by recombination of EHs. The emitted secondary electrons bind with the holes in surface volume of the insulator particles, forming electron cloud in front of the insulator particles. The invented CL phosphor particles are the particular insulator, which have luminescent centers for recombination of electrons and holes in the particles. Beside the luminescent centers, the invented phosphor particles do not have any other insulator or any interlayer on the surface that means the phosphor particles have a clean surface. The holes in the surface volume of the phosphor particles disappear by recombination with electrons at the luminescent centers. The binding electrons on the surface volume lose the binding partners, and then become free electrons. Those free electrons have anisotropic mobility on the phosphor screen. The mobility is high in horizontal direction and is low in vertical direction against the phosphor screen. By the anisotropic mobility, the electrons smoothly move in front of the phosphor screen according to the potential difference in the Xe gas chamber. This is the reason that the present commercial PDP production requires the dielectric layer 27 and the MgO thin film 21 for Xe gas discharge. The MgO thin film 21 emits the secondary electrons, and oxygen-vacancies in MgO form the recombination centers, generating the free electrons on the surface of the MgO thin film 21.

Since the invented CL phosphor screens have the anisotropic electrons in front of the phosphor screen, the MgO thin film 21 and the dielectric glass layer 27 can be substituted by the phosphor screen of the invented phosphor particles.

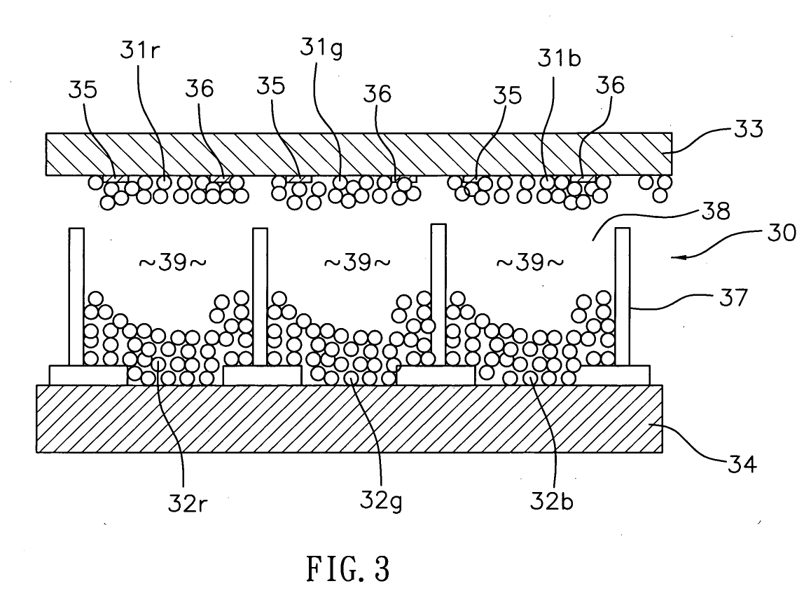

FIG. 3 illustrates the partial cross-sectional view of the phosphor screens in a PDP of the present invention. The PDP 30 comprises phosphor screens 31r, 31g, and 31b, are respectively red, green, and blue phosphor screens which are directly screened on a front plate glass 33 on which has transparent electrodes 35 and 36. The color phosphor screens 31r, 31g, and 31b on the front glass plate 33 should correspond to color phosphor screens 32r, 32g, and 32b on ribs 37 and a base glass plate 34, and chambers 38 filled with discharge gases 39.

Then, it makes a possible to lower the production cost of PDP significantly. In present commercial production, the MgO thin film 21 as shown in FIG. 2 is produced by the evaporation of MgO and/or decomposition of the evaporated Mg-organic film by heat in oxygen atmosphere at high temperature. The production of the MgO thin film in the large area (for example 40 inch diagonal) greatly pushes up the cost of the PDP production. The formation of the transparent dielectric layer 27 (glass layer) is required screening and heating of the PDP plates. The holding of the high tolerance of the color pixels is a hard by the repetition of the heat cycles to the high temperatures of the large sizes and thick glass plate of PDP. To hold the tolerance of the color pixels also pushes up the production cost to a high level. The problems can be taken away from the PDP production by application of the invented phosphors. The phosphor powder can be directly screened on the pixel areas by a print screening technique without applying the MgO thin film on the dielectric layer. The heat of the phosphor screens is once for backing-out of the organic binder in the phosphor screen. The production cost of PDP is remarkably reduced by application of the printed screen of the invented phosphor powders on the pixel areas.

Furthermore, as the phosphor screens are made on the pixel areas, the PL from the phosphor screen on the pixels is additional PL for PDP. The Xe gas charge occurs between the electrodes, and the gap between the Xe gas discharge path and the phosphor screens is shortened, reducing to the self-absorption of the VUV lights. This gives the brighter PL from the phosphor screen, as compared with the PL intensities from the phosphor screens on the ribs and the base plate, which have the large distance between the Xe gas discharge path and the phosphor screens. As the PL color of the phosphor screens on the pixels on the front glass plate 33 has the same PL color of the phosphor screen on the wall of the corresponding to the ribs on the base glass plate 34, the generated PL in each image pixel on the PDP screen markedly increases the image luminance of PDP.

What is claimed is:

1. A color phosphor screen for plasma display device, characterized in that said color phosphor screen comprising phosphors of Y₂O₂S:Eu³⁺, Y₂O₂S:Pr³⁺, and ZnS:Ag:Cl having a clean surface for emission of photoluminescence under irradiation of vacuum ultraviolet lights.

2. The color phosphor screen according to claim 1, wherein the phosphors having a clean surface emit cathodoluminescence under electrons of 300 eV.

3. The color phosphor screen according to claim 1, wherein the plasma display device comprising:
a front plate through which the light is emitted;
electrodes disposed on the front plate;
a rear plate;
ribs disposed between the front plate and the rear plate; and
color phosphor screen is disposed between the front plate and the rear plate.

4. The color phosphor screen according to claim 3, wherein the color phosphor screen is disposed on the rib structure in the plasma display device.

5. The color phosphor screen according to claim 3, wherein the color phosphor screen is disposed on the inner surface of the front plate.

6. The color phosphor screen according to claim 5, wherein the electrodes are covered with the color phosphor screen.

7. A color phosphor screen for plasma display device, characterized in that the color phosphor screen comprises phosphors of Y₂O₂S:Eu³⁺, Y₂O₂S:Pr³⁺, and at least one selected from BaMgAl₁₀O₁₇:Eu²⁺, BaMg₂Al₁₆O₂₇:Eu²⁺, and (Sr,Ba,Ca)₅(PO₄)₃Cl:Eu²⁺, of which phosphors Y₂O₂S:Eu³⁺ and Y₂O₂S:Pr³⁺ have a clean surface for emission of photoluminescence under irradiation of vacuum ultraviolet lights.

8. The color phosphor screen according to claim 7, wherein Y₂O₂S:Eu³⁺ and Y₂O₂S:Pr³⁺ having a clean surface emit cathodoluminescence under electrons of 300 eV.

9. The color phosphor screen according to claim 7, wherein the plasma display device comprising:
a front plate through which the light is emitted;
electrodes disposed on the front plate;
a rear plate;
ribs disposed between the front plate and the rear plate; and
color phosphor screen is disposed between the front plate and the rear plate.

10. The color phosphor screen according to claim 9, wherein the color phosphor screen is disposed on the rib structure in the plasma display device.

11. The color phosphor screen according to claim 9, wherein the color phosphor screen is disposed on the inner surface of the front plate.

12. The color phosphor screen according to claim 11, wherein the electrodes are covered with the color phosphor screen.

13. A white phosphor screen for a mercury-free flat fluorescent lamp, characterized in that the white phosphor screen comprises phosphors of Y₂O₂S:Eu³⁺, Y₂O₂S:Pr³⁺, and ZnS:Ag:Cl having a clean surface for emission of photoluminescence under irradiation of vacuum ultraviolet lights.

14. The white phosphor screen according to claim 13, wherein the phosphors having a clean surface emit cathodoluminescence under electrons of 300 eV.

15. A white phosphor screen for a mercury-free flat fluorescent lamp, characterized in that the white phosphor screen comprises phosphors of Y₂O₂S:Eu³⁺, Y₂O₂S:Pr³⁺, and at least one selected from BaMgAl₁₀O₁₇:Eu²⁺, BaMg₂Al₁₆O₂₇:Eu²⁺, and (Sr,Ba,Ca)₅(PO₄)₃Cl:Eu²⁺, of which phosphors Y₂O₂S:Eu³⁺ and Y₂O₂S:Pr³⁺ have a clean surface for emission of photoluminescence under irradiation of vacuum ultraviolet lights.

16. The white phosphor screen according to claim 15, wherein Y₂O₂S:Eu³⁺ and Y₂O₂S:Pr³⁺ having a clean surface emit cathodoluminescence under electrons of 300 eV.

17. A white phosphor screen for a mercury-free flat fluorescent lamp, characterized in that the white phosphor screen comprises a phosphor selected from those of Y₂O₂S:Eu³⁺:Tb³⁺ and Y₂O₂S:Eu³⁺:Tb³⁺:Pr³⁺ having a clean surface for emission of photoluminescence under irradiation of vacuum ultraviolet lights.

18. The white phosphor screen according to claim 17, wherein the phosphor having a clean surface emit cathodoluminescence under electrons of 300 eV.
